(19) United States
(12) Patent Application Publication
(10) Pub. No.: US 2008/0157648 A1
(43) Pub. Date: Jul. 3, 2008

(54) Field emission display device

(75) Inventors: Hung-Yuan Li, Taipei (TW); Jian-Min Jeng, Taipei (TW)

Correspondence Address: BACON & THOMAS, PLLC, 625 SLATERS LANE, FOURTH FLOOR, ALEXANDRIA, VA, 22314, US

(73) Assignee: Tatung Company, Taipei (TW)

(21) Appl. No.: 11/878,477

(22) Filed: Jul. 25, 2007

(30) Foreign Application Priority Data
Dec. 29, 2006 (TW) 095149947

(51) Int. Cl. H01J 1/62

(52) U.S. Cl. 313/495

(57) ABSTRACT

The present invention relates to a field emission display device, especially to a field emission display device with a lower gate field emission structure. The field emission display device includes an upper substrate, a lower substrate, an anode layer, a plurality of gate layers, an insulation layer covering on the surface of the upper substrate and the gate layers, a plurality of cathode layers formed on the surface of the insulation layer, and a plurality of field emitter layers formed on the surface of the cathode layers. Moreover, the anode layer is formed on the surface of the upper substrate corresponding to the surface of the lower substrate. The gate layers are formed on the surface of the lower substrate corresponding to the surface of the upper substrate. The cathode layers are interlaced with the gate layers, but without conducting to the gate layers.

### BACKGROUND OF THE INVENTION

1. Field of the Invention

The present invention relates to a field emission display device, and, more particularly, to a field emission display device with a lower gate field emission structure.

2. Description of Related Art

FIG. 1 shows a cross-sectional view of a conventional field emission display device. The conventional field display device 1 shown in FIG. 1 comprises: a lower substrate 11, an upper substrate 12, an anode layer 13 formed on the surface of the upper substrate 12 corresponding to the lower substrate 11, an insulation layer 14 formed on the surface of the lower substrate 11, a plurality of cathode layers 15 formed on the surface of the insulation layer 14, a plurality of field emitter layers 16 formed on the surface of the cathode layers 15, and a plurality of gate layers 18 placed on top of an insulation layer 17. The aforementioned insulation layer 17 is placed between every cathode layer 15, so as to partition the cathode layers 15 from each other.

In addition, as shown in FIG. 1, a plurality of phosphor areas 131 and a plurality of black matrix areas 132 are placed on the anode layer 13. These phosphor areas 131 correspond to the emitter layers 16. Furthermore, these black matrix areas 132 are placed to increase the contrast and the resolution of display images of the field emission display device in the first preferred embodiment of the present invention. However, the conventional field emission display device still has many shortcomings to be overcome. For example, because the gate layer is placed on the top of the insulation layer 17, i.e. over the field emission layer 16, abnormal conduction between the gate layer 18 and the field emission layer 16 easily occurs during operation of the conventional field emission display device. Besides, if the thickness of the insulation is decreased in order to achieve higher electronic efficiency, the abnormal conduction may also occur. Moreover, the gate layer 18 of the conventional field emission display device produces a very uneven gate electric field. Particularly, the voltage of the gate electric field on the surface of the field emitter layer 16 is not a constant value. Therefore, when electrons are driven out from the field emitter layer 16, the field emission is not produced on the surface of the field emitter layer 16 at the same time. In other words, the field emission is produced from the edge surface of the field emitter layer 16, and then in sequence from the center surface of the field emitter layer 16. Hence, the brightness of every display pixel in the field emission display device usually appears unevenly. In order to produce field emission on the whole surface of the field emitter layer 16, the greater electric field is brought thereon. Consequently, the conventional field emission display device is required to consume more power, and easily has uneven brightness of pixels.

As a result, a field emission display device, especially one having a lower gate field emission structure, is necessary for the industry to satisfy market requirements. The field emission display device has advantages of an increased uniformity and a lower power consumption relative to prior art.

### SUMMARY OF THE INVENTION

In the present invention, a field emission display device comprises: an upper substrate; a lower substrate; an anode layer, which is formed on the surface of the upper substrate corresponding to the surface of the lower substrate; a plurality of gate layers, which are formed on the surface of the lower substrate corresponding to the surface of the upper substrate; an insulation layer covering on the surface of the upper substrate and the gate layers; a plurality of cathode layers formed on the surface of the insulation layer, which are interlaced with the gate layers, but without conducting to the gate layers; and a plurality of field emitter layers formed on the surface of the cathode layers.

In the present invention, a field emission back light module includes: an upper substrate; a lower substrate; an anode layer, which is formed on the surface of the upper substrate corresponding to the surface of the lower substrate; a plurality of gate layers, which are formed on the surface of the lower substrate corresponding to the surface of the upper substrate; an insulation layer covering on the surface of the upper substrate and the gate layers; a cathode layer formed on the surface of the insulation layer; and a plurality of field emitter layers formed on the surface of the cathode layer.

The gate layer of the field emission display device in the present invention is not adjacent to the cathode layer, but is under the cathode layer. Accordingly, the field emission display device of the present invention has a “lower gate field emission structure”. Furthermore, an insulation layer is placed between the cathode layer and the gate layer. When the field emission display device of the present invention displays an image, the abnormal conduction between the gate layer and the field emitter layers can be decreased dramatically. In other words, the display image of the field emission display device in the present invention can be more stable, and the lifespan thereof can be extended. Because of the lower gate field emission structure in the field emission display device of the present invention, a uniform gate electric field on the surface of the field emitter layers can be provided. Hence, operation of the every display pixel can be controlled. In the field emission display device of the present invention, the resolution of the display image can be increased. In another aspect, due to the gate layer, the field emission back light module of the present invention can carry out the scanning. The field emitter layers corresponding to the scanned gate layer are inhibited against emitting electrons by the gate electric field thereon. Therefore, if the field emission back light module of the present invention can provide stable back light, the lifespan thereof will be further extended, and the power consumption thereof will be decreased.

The field emission display device of the present invention can include a gate layer in any shape. Preferably, the gate layer is strip-like. The field emission display device of the present invention can include a cathode layer in any shape. Preferably, the cathode layer is strip-like. The field emitter layers in the field emission display device of the present invention can be formed on any position of the surface of the cathode layer. Preferably, the field emitter layers are formed on the part of the surface where the cathode layers and the field emitter layers are interlaced. The field emitter layers in the field emission display device of the present invention can be in any shape. Preferably, the field emitter layers are cylindrical, conical or cuboidal. The field emitter layers in the field emission display device of the present invention can be in any size. Preferably, the diameter of the field emitter layers ranges between 150 μm and 250 μm. The gate layers of the field emitter layers in the field emission display device of the present invention can be formed on the lower substrate by any method. Preferably, the gate layers are formed on the lower substrate by way of screen printing, semiconductor process, or photolithography.

The field emission back light module of the present invention can include the gate layers in any shape. Preferably, the gate layers are strip-like. The field emission back light module of the present invention can include the cathode layer in any shape. Preferably, the cathode layer is plate-like. The field emitter layers in the field emission back light module of the present invention can be formed in any position of the surface of the cathode layer. Preferably, the field emitter layers are formed on the surface of the cathode layers, and correspond to the gate layers. The field emitter layers in the field emission back light module of the present invention can be in any shape. Preferably, the field emitter layers are strip-like. The gate layers of the field emitter layers in the field emission back light module of the present invention can be formed on the lower substrate by any method. Preferably, the gate layers are formed on the lower substrate by way of screen printing, semiconductor process, or photolithography.

Other objects, advantages, and novel features of the invention will become more apparent from the following detailed description when taken in conjunction with the accompanying drawings.

### BRIEF DESCRIPTION OF THE DRAWINGS

FIG. 1 is a cross-sectional view of a conventional field emission display device;

FIG. 2A is a cross-sectional view of the field emission display device in a first preferred embodiment of the present invention;

FIG. 2B is a stereo drawing of the field emission display device in the first preferred embodiment of the present invention;

FIG. 3A is a model for simulating the field emission display device in the first preferred embodiment of the present invention;

FIG. 3B is a perspective view of distribution of the gate electric field through simulation by the software; and

FIG. 4 is a stereo drawing of the field emission back light module in second preferred embodiment of the present invention.

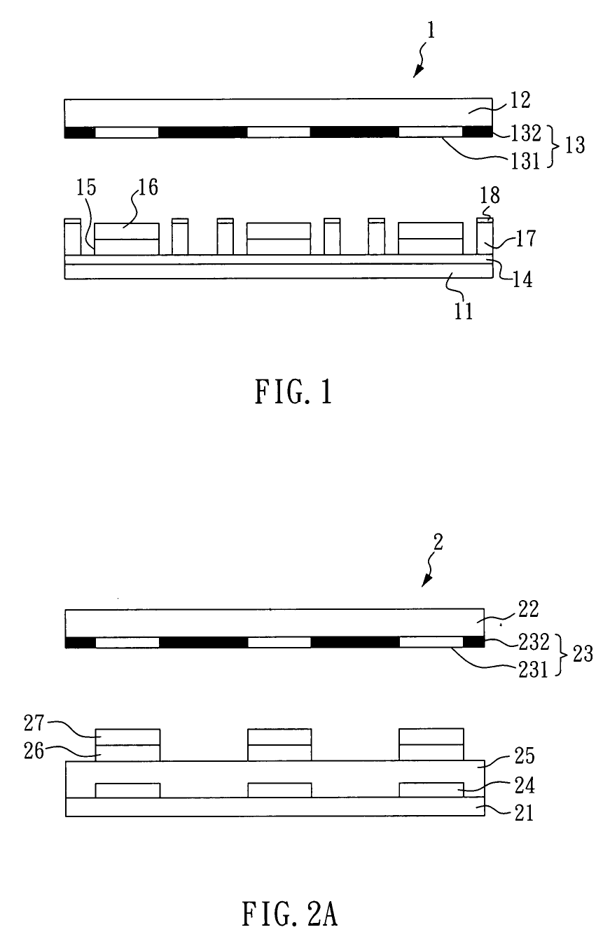

### DETAILED DESCRIPTION OF THE PREFERRED EMBODIMENT

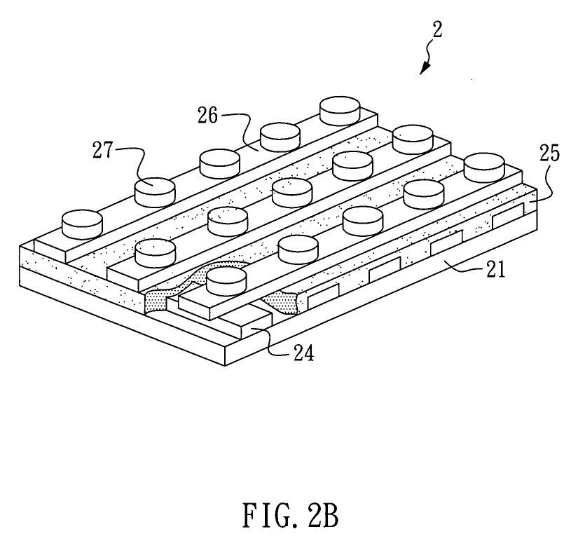

FIG. 2A is a cross-sectional view of the field emission display device in the first preferred embodiment of the present invention and shows the field emission display device 2 which includes: a lower substrate 21, an upper substrate 22, an anode layer 23 formed on the surface of the upper substrate 22 corresponding to the surface of the lower substrate 21, a plurality of gate layers 24 formed on the surface of the lower substrate 21 corresponding to the surface of the upper substrate 22, an insulation layer 25 covering on the gate layers 24 and the surface of the upper substrate 22, a plurality of cathode layers 26 formed on the surface of the insulation layer 25, and a plurality of field emitter layers 27 formed on the surface of the cathode layers 26. FIG. 2B is a stereo drawing of the field emission display device in the first preferred embodiment of the present invention. In order to simplify the drawing, the upper substrate and the anode layer thereon are omitted in the drawing. The cathode layers 26 of the field emission display device in first preferred embodiment of the present invention are interlaced with the gate layers 24, but they are conducted to each other. The gate layers 24 and the cathode layers 26 are strip-like. Moreover, the aforementioned field emitter layers 27 are formed on the surface of the cathode layers 26 interlaced with the gate layers 24. The field emitter layers 27 are cylindrical, and the diameter thereof is preferred to be between 150 μm and 250 μm. Furthermore, a plurality of carbon nanotubes or metal semiconductors (not shown in FIG. 2B) are also adhered thereon and can further the efficiency of electrons leaving from the surfaces of the field emitter layers 27, i.e. the efficiency of having field emission.

Besides, as shown in FIG. 2A, a plurality of phosphor areas 231 and a plurality of black matrix areas 232 are placed on the anode layer 23. These phosphor areas 231 correspond to the above field emitter layers 27. These black matrix areas 232 are used for increasing the contrast and the resolution of display images exhibited by the field emission display device in the first preferred embodiment of the present invention. Then, in the present preferred embodiment, the gate layers of the field emission display device in the present invention are printed on the surface of the lower substrate 21 through screen printing or other means, e.g. semiconductor processes or photolithography. Similarly, in the present preferred embodiment of the present invention, the lower substrate 21 and the upper substrate 22 of the field emission display device are glass substrates. The insulation layer 25 is made of a dielectric material with a dielectric coefficient of about 13.

Further, as shown in FIG. 2A, the gate layers 24 of the field emission display device in the first preferred embodiment of the present invention are placed under the cathode layers 26. In other words, the field emission display device in the first preferred embodiment of the present invention has a lower gate field emission structure. During operation of the field emission display device, this lower gate field emission structure can efficiently decrease the probability of the abnormal conduction between the gate layers and the field emitter layers, and also can provide a uniform gate electric field on the surfaces of the field emitter layer, so as to efficiently restrain electrons from leaving from the surface of the field emitter layers, and to promote the contrast and the resolution of images displayed by the field emission display device.

Hereinafter, through simulation software, i.e. Flex™ pde, the results thereof prove that the gate layer actually provides a uniform gate electric field on the surfaces of the emitter layers during operation of the field emission display device in the first preferred embodiment of the present invention. Hence, operation of every display pixel is controlled in the field emission display device.

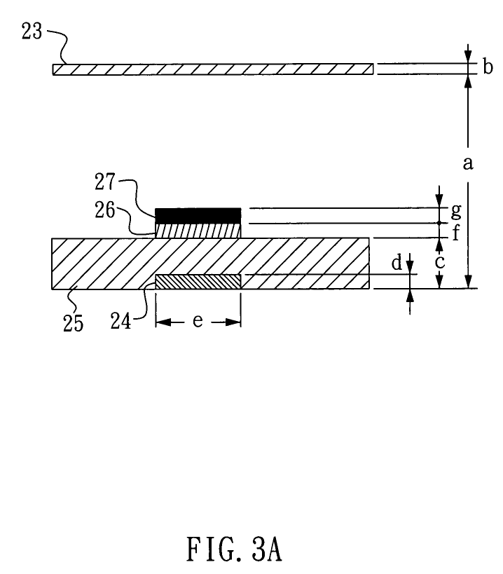

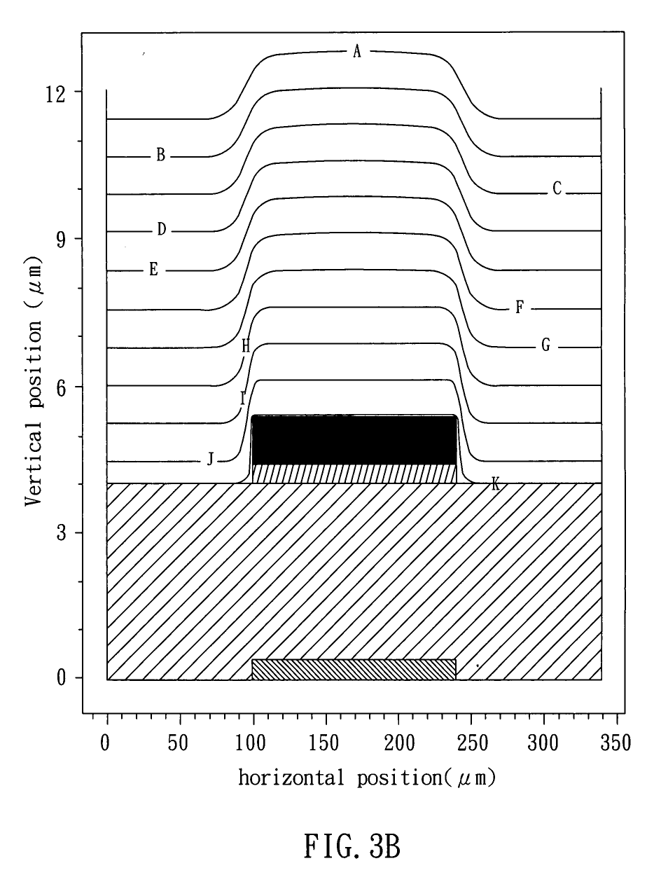

FIG. 3A is a perspective view of a model for simulating the field emission display device in the first preferred embodiment of the present invention and it exhibits various parameters of the model for the field emission display device in first preferred embodiment of the present invention. The distance a between the lower surface of the insulation layer 25 and the lower surface of the anode layer 23 is 50 μm. The thickness b of the anode layer 23 is 10 μm. The thickness c of the insulation layer 25 is 4 μm. The thickness d of the gate layers 24 is 0.4 μm. The width e of the gate layers 24 is 140 μm. The thickness f of the cathode layers 26 is 0.4 μm. The thickness g of the field emitter layers 27 is 1 μm. In addition, during operation of the field emission display device in the first preferred embodiment of the present invention, the potential of the gate layers 24 is −80 volts. The potential of the cathode layers 26 is 0 volt. The potential of the anode layer 23 is 300 volts.

FIG. 3B is a perspective view of the distribution of the gate electric field from simulation software, and also exhibits the space distribution of the gate electric field in the whole field emission display device during operation of the gate layers 24 thereof in the first preferred embodiment of the present invention. It is noted that the denoted ratio of X axis is not the same as that of Y axis, for the purpose of more clearly exhibiting the structure of the field emission display device in the first preferred embodiment of the present invention. Furthermore, curves A to K in FIG. 3B respectively represent the different space distributions of the gate electric field under different potentials. In other words, a position in space under the same curve has the same potential of the gate electric field produced by the gate layers 24.

Then, it is noted that the curve K is extended along the surfaces of the insulation layer 25 and the field emitter layers 27 of the whole field emission display device in the first preferred embodiment of the present invention. The curve K shows that the gate electric field produced by the gate layers 24 has the same potential both on the surfaces of the insulation layer 25 and the field emitter layers 27. In other words, as the field emission display device in the first preferred embodiment of the present invention exhibits images, and some display pixel thereof is set to be a dark condition, the gate layer 24 corresponding to this display pixel can produce a uniform gate electric field on the surface of the field emitter layer 27 corresponding to this display pixel (such as the aforementioned curve K). Therefore, electrons are efficiently held on the whole surface of the field emitter layer 27, and then can not leave out of the surface of the field emitter layer 27. This display pixel thereupon has no brightness so that the contrast of the images displayed by the field emission display device in the first preferred embodiment of the present invention becomes higher, and images thereof become clearer.

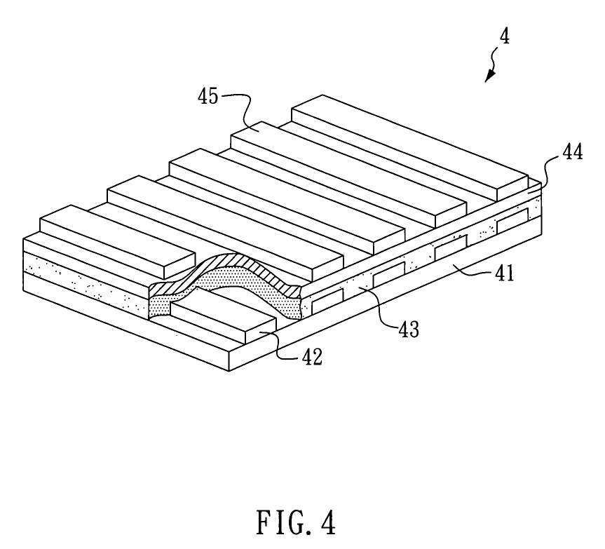

FIG. 4 is a stereo drawing in a perspective view of the field emission back light module in the second preferred embodiment of the present invention. For simplifying the drawing, an upper substrate, an anode layer deposited on the surface of the upper substrate, and a plurality of phosphor areas therein are omitted and are not drawn. As shown in FIG. 4, a field emission back light module 4 in the second preferred embodiment of the present invention includes: a lower substrate 41; an upper substrate (not shown in FIG. 4); an anode layer (not shown in FIG. 4) formed on the surface of the upper substrate (not shown in FIG. 4) corresponding to the lower substrate 41; a plurality of gate layers 42 formed on the surface of the lower substrate 41 corresponding to the upper substrate (not shown in FIG. 4); an insulation layer 43 covering on the surface of the lower substrate 41 and on the gate layers 42; a cathode layer 44 formed on the surface of the insulation layer 43; and a plurality of field emitter layers 45 formed on the surface of the cathode layer 44. As shown in FIG. 4, these gate layers 42 and these field emitter layers 45 are all strip-like. Additionally, these field emitter layers 45 corresponding to these gate layers 42 are formed on the surface of the cathode layer 44 in shape of a plate. Besides, a plurality of carbon nanotubes or metallic semiconductors (not shown in FIG. 4) can also be adhered on the surfaces of these field emitter layers 45. Therefore, electrons are further efficiently driven out of the surfaces of the field emitter layers 45 so as to promote the efficiency of field emission.

In addition, a plurality of phosphor areas are deposited on the anode layer (not shown in FIG. 4) of the field emission back light module in the second preferred embodiment of the present invention. These phosphor areas (not shown in FIG. 4) are deposited by way of corresponding to the aforementioned field emitter layers 45. Besides, in this preferred embodiment, the gate layers in the field emission back light module of the present invention are printed on the surface of the lower substrate 41 through screen printing or other means, e.g. semiconductor processes or photolithography. Likewise, in the present preferred embodiment, the lower substrate 41 and the upper substrate (not shown in FIG. 4) layers in the field emission back light module of the present invention are glass substrates, and the insulation layer 43 therein is made of a material having a dielectric coefficient of about 13.

Moreover, as shown in FIG. 4, the gate layers 42 in the field emission back light module of the present invention are placed under the cathode layer 44. In other words, the field emission back light module in the second preferred embodiment of the present invention has a lower gate field emission structure. During operation of the field emission back light module having the lower gate field emission structure, the strip-like gate layers 42 are scanned, and then the field emitter layers 45 corresponding to those gate layers 42 do not emit electrons due to inhibition of the gate electric field applied thereon.

Additionally, through the above scanning, electrons are not emitted from the field emitter layers 45 corresponding to the scanned gate layers 42. Hence, the field emission back light module in the second preferred embodiment of the present invention has several scanning dark fringes in continuous action. However, the function efficiency of the field emission back light module in the second preferred embodiment of the present invention is not remarkably affected by the above scanning because human eyes have a characteristic of visual persistence. Therefore, users are unaware that these action scanning dark fringes are in existence, and they are still under the impression of that the whole surface of the field emission back light module shines uniformly. The field emitter layers 45 of the field emission back light module in the second preferred embodiment of the present invention provides illuminants having the same brightness in the shorter emission time. Hence, on the premise of providing back light sources having the same quality, the lifespan of the field emission back light module in the second preferred embodiment of the present invention is further prolonged through no electron emission from the field emitter layers 45 corresponding to the scanned gate layers 42, so that the power consumption can be dramatically retrenched.

In conclusion, the gate layers of the field emission display device are not close to the cathode layers, but are under the cathode layer. In other words, the field emission display device of the present invention has a lower gate field emission structure. Furthermore, because there is an insulation layer placed between the gate layers and the cathode layers, probability of the abnormal conduction between the gate layers and the field emitter layers can be remarkably reduced during operation of the field emission display device in the present invention. Therefore, the field emission display device of the present invention can exhibit more stable images, and the lifespan thereof can be further prolonged. Besides, because the field emission display device of the present invention has a lower gate field emission structure that can provide a uniform gate electric field on the surfaces of the field emitter layers to control operation of every display pixel, resolution of images displayed from the field emission display device of the present invention can be further promoted. Additionally, through scanning the gate layers of the field emission back light module in the present invention, the field emitter layers corresponding to the scanned gate layers can not emit electrons due to inhibition of the gate electric field applied on the surfaces of the field emitter layers. Hence, on the premise of providing the back light sources having the same quality, the field emission back light module of the present invention can have a further prolonged lifespan, and economize remarkably on power consumption.

Although the present invention has been explained in relation to its preferred embodiment, it is to be understood that many other possible modifications and variations can be made without departing from the scope of the invention as hereinafter claimed.

What is claimed is:

1. A field emission display device comprising:
a lower substrate;
an upper substrate;
an anode layer, which is formed on the surface of the upper substrate corresponding to the surface of the lower substrate;
a plurality of gate layers, which are formed on the surface of the lower substrate corresponding to the surface of the upper substrate;
an insulation layer covering on the surface of the upper substrate and the gate layers;
a plurality of cathode layers formed on the surface of the insulation layer, which are interlaced with the gate layers, but without conducting to the gate layers; and
a plurality of field emitter layers formed on the surface of the cathode layers.

2. The field emission display device as claimed in claim 1, wherein the gate layers are strip-like.

3. The field emission display device as claimed in claim 1, wherein the cathode layers are strip-like.

4. The field emission display device as claimed in claim 1, wherein the field emitter layers are formed on the part of the surface where the cathode layers and the field emitter layers are interlaced.

5. The field emission display device as claimed in claim 1, wherein the field emitter layers are cylindrical or cuboidal.

6. The field emission display device as claimed in claim 5, wherein the diameter of the field emitter layers is between 150 μm and 250 μm.

7. The field emission display device as claimed in claim 1, wherein the field emitter layers are adhered with a plurality of carbon nanotubes or metallic semiconductors.

8. The field emission display device as claimed in claim 1, wherein the anode layer further comprises a plurality of phosphor areas and a plurality of black matrix areas set thereon.

9. The field emission display device as claimed in claim 8, wherein the phosphor areas independently correspond to the field emitter layers.

10. A field emission back light module comprising:
a lower substrate;
an upper substrate;
an anode layer, which is formed on the surface of the upper substrate corresponding to the surface of the lower substrate;
a plurality of gate layers, which are formed on the surface of the lower substrate corresponding to the surface of the upper substrate;
an insulation layer covering on the surface of the upper substrate and the gate layers;
a cathode layer formed on the surface of the insulation layer; and
a plurality of field emitter layers formed on the surface of the cathode layer.

11. The field emission back light module as claimed in claim 10, wherein the gate layers are strip-like.

12. The field emission back light module as claimed in claim 10, wherein the cathode layer is plate-like.

13. The field emission back light module as claimed in claim 10, wherein the field emitter layers are formed on the surface of the cathode layers, and correspond to the gate layers.

14. The field emission back light module as claimed in claim 10, wherein the field emitter layers are strip-like.

15. The field emission back light module as claimed in claim 10, wherein the field emitter layers are adhered with a plurality of carbon nanotubes or metallic semiconductors.

16. The field emission back light module as claimed in claim 10, wherein the anode layer further comprises a plurality of phosphor areas set thereon.

17. The field emission back light module as claimed in claim 16, wherein the phosphor areas independently correspond to the field emitter layers.
